(19) United States
(12) Patent Application Publication
(10) Pub. No.: US 2024/0246881 A1
(43) Pub. Date: Jul. 25, 2024

(54) APPARATUS FOR RAPID DRYING AND FERMENTATION OF ORGANIC WASTE

(71) Applicant: ENERGY PLUS TECHNOLOGY, Anyang-si (KR)

(72) Inventor: Kil Dong HUH, Anyang-si (KR)

(21) Appl. No.: 18/564,152

(22) PCT Filed: May 3, 2022
(86) PCT No.: PCT/KR2022/006354

§ 371 Date: Nov. 27, 2023

(30) Foreign Application Priority Data
May 26, 2021 (KR) 10-2021-0067672
Feb. 17, 2022 (KR) 10-2022-0020505

(51) Int. Cl. C05F 17/929; C05F 3/06

(52) U.S. Cl. CPC C05F 17/929; C05F 3/06

(57) ABSTRACT

A high-speed organic waste dry/fermentation apparatus, which is capable of drying/fermenting organic waste at high speed by smoothly supplying air, includes: a fermentation tank arranged vertically on a ground, having a space in which an organic waste is accommodated, and configured to perform a dry/fermentation process on the organic waste; a stirrer provided in the fermentation tank and configured to stir the organic waste accommodated in the fermentation tank; and an air supplier configured to supply air into the fermentation tank through at least one spray stirring blade of the stirrer, wherein the air supplier is configured to selectively supply an external air from a blower and a high-pressure compression air from a compressor.

### FIELD

The present disclosure relates to a high-speed organic waste dry/fermentation apparatus for drying and fermenting organic waste such as livestock manure.

### BACKGROUND

For example, organic waste, including livestock manure discharged from a livestock farm may be dried and fermented by a resource facility and re-treated as compost, or the like.

A dry/fermentation apparatus for resourcing livestock manure or the like includes a fermentation tank and stirring blades provided inside the fermentation tank. organic waste accommodated in the fermentation tank undergoes fermentation while being continuously stirred by the stirring blades.

In the related art, there is a structure in which, in a double hollow shaft composed of an inner hollow shaft and an outer hollow shaft, the inner hollow shaft penetrates through the outer hollow shaft and is connected to a stirring blade. In such a structure, when the stirrer is rotated, a connection pipe which connects the hollow shaft and the stirring blade acts as a cause of load against the rotation of the hollow shaft. As a result, the load acts as resistance during the rotation, which may cause breakage of the stirring shaft.

In addition, when the connection pipe is broken due to a horizontal displacement and vertical drop of the stirring blade, a decrease in amount of introduced external air may occur, resulting in a decrease in efficiency of aerobic fermentation.

Fermentation of the organic waste is performed by organic decomposition of aerobic microorganisms. In order to decompose large quantities of organic matters in a short period of time and at high speed, it is necessary to smoothly supply air necessary for increase in populations of microorganisms into the fermentation tank. The injection of air is usually performed by the stirring blade at the bottom of the fermentation tank.

However, a structure in which the air is supplied from the bottom of the fermentation is difficult to uniformly supply the air to the whole waste accommodated in the fermentation tank, which may cause a deterioration in fermentation efficiency.

In the case of the structure in which the air is injected by the stirring blade, the air may be supplied more uniformly and high-viscosity wastes may also be treated. However, such a structure is very complex, which makes installation and maintenance difficult. In addition, the structure in the related art may make a smooth discharge of the air difficult, and may often cause clogging of nozzles. That is, an apparatus in the related art has a simple structure in which the air is continuously supplied to an internal space of the stirring blade through the blower, and is discharged via holes. This makes it difficult to smoothly discharge the air, which may easily cause clogging of the nozzles formed in the stirring blade. For high-viscosity wastes, the uniform supply of the air is further difficult, which reduces fermentation efficiency. As a result, the operation needs to be performed at low level, which reduces productivity.

In addition, there is a limit to increasing air supply pressure using the blower. This makes it difficult to supply the air to each stirring blade and inject the air through the nozzles at a desired flow velocity and flow rate. As a result, the smooth supply of the air through the stirring blade is difficult, which causes a difficulty in eliminating clogging of the nozzles.

In recent years, there has been a higher demand for faster and efficient fermentation facilities to meet the demand for resourcing the livestock manure. In this regard, a dry/fermentation in the related art needs to be improved to provide many advantages to users.

### DOCUMENT IN RELATED ART

### Patent Document

Patent Document 1: Korean Patent Application Registration No. 10-1512374
Patent Document 2: Korean Patent Application Publication No. 10-2020-0109912

### SUMMARY

The present disclosure is for the purpose of providing a high-speed organic waste dry/fermentation apparatus which produces fermented organic matter by drying and fermenting organic waste in a short period of time.

The object of the present disclosure is for the purpose of providing a high-speed organic waste dry/fermentation apparatus which produces fermented organic matter by enhancing durability of a stirring blade to prevent a stirring shaft and the stirring blade from being broken due to an external force caused by organic waste inputted into a fermentation tank, and by fermenting the organic waste while stirring the organic waste with a strong rotational force.

The object of the present disclosure is for the purpose of providing a high-speed organic waste dry/fermentation apparatus which produces dried/fermented organic matter by eliminating a cause of reducing performance of aerobic fermentation and enhancing driving efficiency using an external-air introduction system for preventing breakage of a connection pipe and clogging of air holes when external air is introduced.

The object of the present disclosure is for the purpose of providing a high-speed organic waste dry/fermentation apparatus which is capable of drying and fermenting organic waste at high speed by supplying air in a smooth manner.

The object of the present disclosure is for the purpose of providing a high-speed organic waste dry/fermentation apparatus which is capable of fundamentally preventing clogging of air injection nozzles provided in an injection stirring blade.

The object of the present disclosure is for the purpose of providing a high-speed organic waste dry/fermentation apparatus which is capable of efficiently supply high-pressure compression air to an end of each injection stirring blade.

The object of the present disclosure is for the purpose of providing a high-speed organic waste dry/fermentation apparatus which is easy to install and maintain.

The present disclosure is not limited to the above-mentioned objects, and other objects not mentioned will be apparent to those skilled in the art from the following descriptions.

According to an aspect of the present disclosure, a high-speed organic waste dry/fermentation apparatus produces a dried/fermented organic matter by rotating a stirring shaft coupled vertically to a lower driver and a stirring blade coupled at a right angle to the stirring shaft with a rotation of the lower driver, stirring the moisture-rich organic waste including livestock manure, sewage/waste water sludge or remaining food, which is inputted into a drum-shaped cylindrical shell fermentation tank, and fermenting the moisture-rich organic waste, wherein the stirring shaft is provided in a central portion of the drum-shaped cylindrical shell-shaped dry/fermentation tank, one end of the stirring blade is supported by the stirring shaft, the stirring blade includes a lower stirring blade arranged at a lowermost end, a middle stirring blade arranged above the lower stirring blade, and an upper stirring blade arranged above the middle stirring blade, and the lower stirring blade, the middle stirring blade and the lower stirring blade are arranged in different structures according to arrangement positions and processing functions of the lower stirring blade, the middle stirring blade and the lower stirring blade.

In an aspect, the upper stirring blade may include a first-stage upper stirring blade arranged at an uppermost end, and a second-stage upper stirring blade just below the first-stage upper stirring blade and having a shape identical to a shape of the first-stage upper stirring blade, wherein the lower stirring blade and the middle stirring blade, which are arranged below the drum-shaped cylindrical shell-shaped dry/fermentation tank and are subjected to a relatively large load, may be formed in a frame structure in which a plurality of plate members are combined with each other, the first-stage upper stirring blade or the second-stage upper stirring blade, which are positioned above the drum-shaped cylindrical shell dry/fermentation tank and are subjected to a relatively small load compared to the lower stirring blade and the middle stirring blade, may be formed by one plate member or in a frame structure in which a plurality of plate members is combined with each other, and the first-stage upper stirring blade and the second-stage upper stirring blade may be formed in different structures according to a magnitude of the load.

In an aspect, each of the lower stirring blade and the first-stage upper stirring blade may include two or more stirring blades provided at the same height in a symmetrical relationship with a central line of the stirring shaft.

In an aspect, each of the middle stirring blade and the upper stirring blade may include a single stirring blade attached to the stirring shaft at the same height.

In an aspect, each of the first-stage upper stirring blade and the second-stage upper stirring blade may include an upper front plate, an upper rear plate, an upper top plate and an upper bottom plate positioned along a traveling direction, and an upper protrusion may be formed on the upper front plate to reduce a rotational resistance.

In an aspect, the lower stirring blade may include a lower front plate, a lower rear plate, a lower top plate and a lower bottom plate positioned along a traveling direction, and a lower protrusion is formed on the lower front plate to reduce a rotational resistance. The lower bottom plate of the lower stirring blade may have a plurality of lower air holes to provide external air to the organic waste to promote fermentation when the lower stirring blade is rotated.

In an aspect, the middle stirring blade includes a middle front plate, a middle rear plate, a middle top plate and a middle bottom plate positioned along the traveling direction, and a middle protrusion is formed on the middle front plate to reduce the rotational resistance, and the middle rear plate of the middle stirring blade may have a plurality of middle air holes to provide external air to the organic waste to promote fermentation when the middle stirring blade is rotated.

In an aspect, the stirring shaft may include a supporting bracket which supports one end of each stirring blade. The supporting bracket may be arranged to be coupled to the stirring shaft. The supporting bracket may be configured to include a first bracket for supporting the middle stirring blade and the second-stage upper stirring blade, which are provided one-by-one at the same height, and a second bracket for supporting the lower stirring blade and the first-stage upper stirring blade, which are provided in plural numbers at the same height.

In an aspect, the first bracket may have a first through-hole into which the stirring shaft is fitted, a first supporting portion for supporting the middle stirring blade and the first-stage upper stirring blade may be provided on one side of the first through-hole, a second through-hole into which the stirring shaft is fitted may be formed in the second bracket, and a second supporting portion for supporting the lower stirring blade and the first-stage upper stirring blade may be provided on both sides or a top side of the second through-hole.

In an aspect, two of the second bracket may be provided above and below the lower stirring blade which is positioned below the drum-shaped cylindrical shell dry/fermentation tank and subjected to a significant load, two of the first brackets may be provided above and below the middle stirring blade, one of the first bracket may be provided below the second-stage upper stirring blade, and one of the second bracket may be provided below the first-stage upper stirring blade.

In an aspect, the middle protrusion may have a shape of an isosceles triangle with the middle front plate as a base, and a first plate member and a second plate member as both sides, and a vertex at which the first plate member and the second plate member meet is positioned at a center of the middle front plate to reduce the rotational resistance when the middle stirring blade is rotated, and the upper protrusion may have the shape of the isosceles triangle with the upper front plate as a base, and a third plate member and a fourth plate member as both sides, and a vertex at which the third plate member and the fourth plate member meet is positioned at a center of the upper front plate to reduce the rotational resistance when the first-stage upper stirring blade and the second-stage upper stirring blade are rotated.

In an aspect, the lower protrusion may have a shape of a right triangle in which the lower front plate functions as a base, a firth plate member and a sixth plate member function as both sides, the fifth plate member is arranged to be parallel to the lower bottom plate and the sixth plate member is arranged in an inclined state, and the shape of the right triangle of the lower protrusion may reduce an upward-biased resistance due to the dried/fermented organic matter that accumulates on a bottom of the drum-shaped cylindrical shell dry/fermentation tank when the lower stirring blade is rotated.

In an aspect, an air supplier configured to supply the external air may be connected to a plurality of lower air holes provided in a lower front plate of the lower stirring blade and the plurality of middle air holes, and the air supplier may include: a blower configured to supply the external air; a first supply pipe through which the external air supplied from the blower flows; a second supply pipe provided inside the stirring shaft and configured to rotate together with the stirring shaft; a switch configured to supply the external air supplied from the first supply pipe to the second supply pipe; a third supply pipe provided inside the middle stirring blade and inside the lower stirring blade and configured to supply the external air supplied from the second supply pipe to the plurality of lower air holes and the plurality of middle air holes; and a branch supply pipe branched at the third supply pipe and configured to supply the external air supplied from the second supply pipe to the plurality of lower air holes and the plurality of middle air holes.

In an aspect, an air compressor may be provided in a certain portion of the first supply pipe, and may be configured to supply high-pressure air to the plurality of lower air holes and the plurality of middle air hole so that some of the plurality of lower air holes and the plurality of middle air holes are not clogged.

According to another aspect of the present disclosure, a high-speed organic waste dry/fermentation apparatus may include: a fermentation tank arranged vertically on a ground, having a space in which an organic waste is accommodated, and configured to perform a dry/fermentation process on the organic waste; a stirrer provided in the fermentation tank and configured to stir the organic waste accommodated in the fermentation tank; and an air supplier configured to supply air into the fermentation tank through at least one spray stirring blade of the stirrer so that the air supplied from the air supplier is supplied toward an end of the stirrer in a smooth manner.

In an aspect, the stirrer may include: a stirring shaft provided rotatably inside the fermentation tank while extending vertically at a center of the fermentation tank; the at least one injection stirring blade provided at intervals along the stirring shaft; and a driver connected to the stirring shaft to rotate the stirring shaft.

In an aspect, the stirrer may include at least one stirring blade arranged above the at least one injection stirring blade along the stirring shaft axis to stir the organic waste without injecting air.

In an aspect, the air supplier may be configured to selectively supply external air from a blower and high-pressure compression air from a compressor.

In an aspect, the air supplier may include: an external air supplier configured to supply an external air; a first air supply pipe connected between the external air supplier and a tip of the stirring shaft and configured to supply the external air supplied from the external air supplier; a plurality of second air supply pipes branched at the first air supply pipe, extending along an interior of the stirring shaft and configured to individually supply the external air using the at least one injection stirring blade; a third air supply pipe provided inside each of the at least one injection stirring blade and connected to one side of the second air supply pipe extending to the at least one injection stirring blade; and at least one injection nozzle provided along the third air supply pipe to inject the external air via a discharge port formed in the at least one injection stirring blade.

In an aspect, the air supplier may include the blower connected to the first air supply pipe to supply the external air.

In an aspect, the air supplier may include a compression air supplier connected to the first air supply pipe to supply compression air.

In an aspect, the compression air supplier may include: a compression pipe connected to the first air supply pipe; a compressor connected to the compression pipe and configured to supply the compression air; an air tank configured to store the compression air; an opening/closing valve configured to open and close the compression pipe; and a check valve provided in the first air supply pipe in front of the blower and configured to prevent the compression air from flowing backward toward the blower.

In an aspect, the third air supply pipe may be fixed on an inner surface in which the discharge port of the at least one injection stirring blade is formed to constitute a single unit, and the at least one injection nozzle formed in the third air supply pipe may be directly connected to the discharge port of the at least one injection stirring blade.

In an aspect, an inner diameter of the first air supply pipe, inner diameters of the plurality of second air supply pipes and an inner diameter of the third air supply pipe may be different from each other.

In an aspect, the inner diameter of the first air supply pipe, the inner diameters of the plurality of second air supply pipes and the inner diameter of the third air supply pipe may become smaller sequentially in an air supply direction.

In an aspect, the air supplier may further include a connector configured to selectively connect between the third air supply pipe and the plurality of second air supply pipes.

In an aspect, the high-speed organic waste dry/fermentation apparatus may further include a controller configured to control the supply of the external air by the blower and the supply of the compression air by the compressor.

In an aspect, a protrusion formed to extend along the at least one stirring blade and having a sharpened triangular cross-sectional shape toward an outer tip of the protrusion may be further provided to reduce a rotational resistance. This makes it possible to reduce a torque of the driver and reduce a driving energy (amount of power).

According to an example embodiment, by arranging injection stirring blades in different structures according to arrangement positions and processing functions thereof, it is possible to prevent a stirring shaft and the injection stirring blades from being broken.

Further, by forming cross-sectional structures of the injection stirring blades in different forms according to degrees of loads applied to the injection stirring blades based on engineering studies for coping with an external force, it is possible to prevent the injection stirring blades from being broken.

Further, by supplying the external air to the organic waste without interrupt, it is possible to promote fermentation.

Further, by flowing high-pressure air with an air compressor when some of lower air holes and middle air holes are clogged, it is possible to immediately open the clogged air holes.

Further, by structural variations as described above, it is possible to prevent damage of the stirring shaft, breakage of the injection stirring blades, collapse and breakage of the fermentation tank, breakage of a connection portion of the driver and the stirring shaft, or the like, which are factors causing a deterioration in the durability of vertical high-speed fermentation apparatus. In particular, it is possible to suppress a deterioration in performance of aerobic fermentation due to breakage of a connection pipe and clogging of air holes when external air is supplied, which may cause a deterioration in a dry/fermentation efficiency of the high-speed fermentation apparatus.

Further, the present disclosure is applicable to various types of organic waste, such as livestock manure, sewage/waste water sludge, food and drink, and the like, which makes it possible to achieve high-durability and high-performance aerobic fermentation.

Further, by more smoothly supplying air into the organic waste through the injection stirring blades, it is possible to dry and ferment the organic waste at high speed.

By performing both the supply of the external air by the blower and the supply of the high-pressure compression air by the compressor, it is possible to increase air supply efficiency and to prevent the discharge ports of the injection stirring blades from clogging.

By dividing the external air and the compression air supplied via a first supply pipe from the blower and the compressor to two or more second air supply pipes provided in a vertical-extending stirring shaft, and supplying the divided air toward a discharge port of an end of each of injection stirring blade via a third supply pipe of the injection stirring blade, it is possible to efficiently supply the air to the end of each injection stirring blade with less energy while minimizing a loss of pressure and to smoothly inject the air from discharge ports of all the injection stirring blades.

Further, by connecting air supply pipes in an easier manner, it is possible to more easily connect and separate the injection stirring blade to and from the stirring shaft, which facilitates installation and maintenance.

Further, by providing a separate air supply pipe in an internal space of each injection stirring blade, it is possible to ensure a degree of freedom of design of the injection stirring blade.

Further, by supplying the compression air, it is possible to smoothly supply air corresponding to an internal water pressure of the vertical fermentation tank. This makes it possible to raise a water level inside the fermentation tank at maximum and treat a greater quantity of organic waste at once, which enhances productivity.

Further, by reducing a rotational resistance of the injection stirring blade, it is possible to reduce a torque of the driver and save a driving energy (amount of power).

### BRIEF DESCRIPTION OF THE DRAWINGS

FIG. 1 is a cross-sectional view schematically illustrating an interior, a supporting frame, a drive part, an organic waste inlet and a stink discharge port of a cylindrical shell-shaped fermentation tank in a high-speed dry/fermentation apparatus according to a first example embodiment.

FIG. 2 is a front view schematically illustrating a stirring shaft and stirring blades of the high-speed dry/fermentation apparatus according to the first example embodiment.

FIGS. 3 and 4 are front views schematically illustrating a state in which an air supplier of the high-speed dry/fermentation apparatus according to the first example embodiment is provided.

FIGS. 5A to SC are perspective views and cross-sectional views schematically illustrating an upper stirring blade, a middle stirring blade, a lower stirring blade, respectively.

FIGS. 6A to 6C is a plan view of a first bracket and a plan view of a second bracket according to the first example embodiment, and a plan view of a second bracket according to another example embodiment, respectively.

FIG. 7 is an explanatory view illustrating a coupled wall module structure of the high-speed organic waste dry/fermentation apparatus according to the first example embodiment.

FIGS. 8A and 8B are partial vertical cross-sectional views of the high-speed organic waste dry/fermentation apparatus according to the first example embodiment when a plurality of wall modules is coupled to each other in a vertical direction to form an outer wall.

FIGS. 9A and 9B are partial horizontal cross-sectional views of the high-speed organic waste dry/fermentation apparatus according to the first example embodiment when the plurality of wall modules is coupled to each other in a horizontal direction to form the outer wall.

FIG. 10 is a view schematically illustrating a high-speed organic waste dry/fermentation apparatus according to a second example embodiment.

FIGS. 11 and 12 are views schematically illustrating a structure of a second air supply pipe of the high-speed organic waste dry/fermentation apparatus according to this example embodiment.

FIG. 13 is a cross-sectional view taken along line A-A in FIG. 3.

### DETAILED DESCRIPTION

Hereinafter, example embodiments of the present disclosure will be described in detail. However, the example embodiments described herein are merely examples and the present disclosure is not limited thereto. The present disclosure is merely defined by the scope of the accompanying claims. The example embodiments to be described below may be modified in various forms without departing from the spirit and scope of the present disclosure. The same or similar parts will be indicated by the same reference numerals in the drawings.

The terminologies used below are merely used to explain a specific example embodiment only, and are not intended to limit the present disclosure. The singular forms “a,” “an,” and “the” may include the plural forms unless specifically stated. The meaning of “including” as used herein specifies a specific characteristic, region, integer, step, operation, element, and/or component, and does not exclude the presence or addition of other specific characteristics, regions, integers, steps, operations, elements, components, and/or groups.

Hereinafter, preferred example embodiments of the present disclosure will be described with reference to the drawings. However, the following example embodiments are merely preferred example embodiments of the present disclosure and the present disclosure is not limited thereto.

Example embodiments described later are applicable to treat various types of organic waste, such as high-viscosity livestock manure, low-viscosity livestock manure, cattle dung, dairy dung, chicken droppings, pig manure, food and drink waste, sewage/waste water sludge, and the like.

### First Example Embodiment

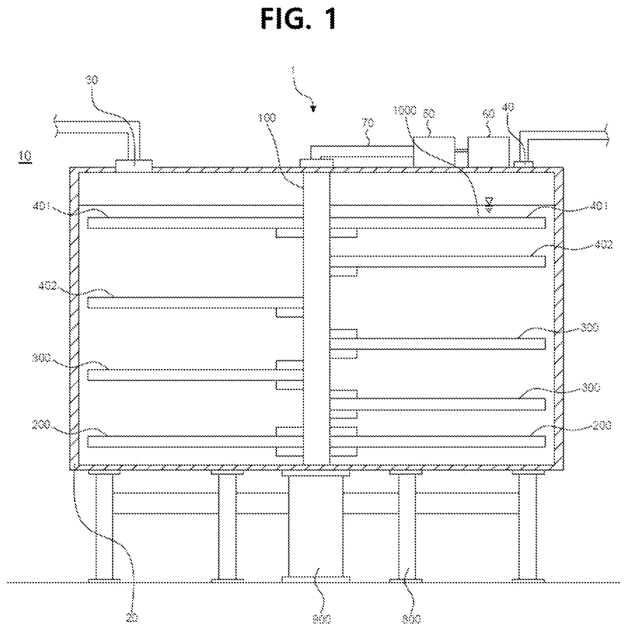

A configuration of a high-speed dry/fermentation apparatus according to a first example embodiment will be described with reference to FIGS. 1 to 9B.

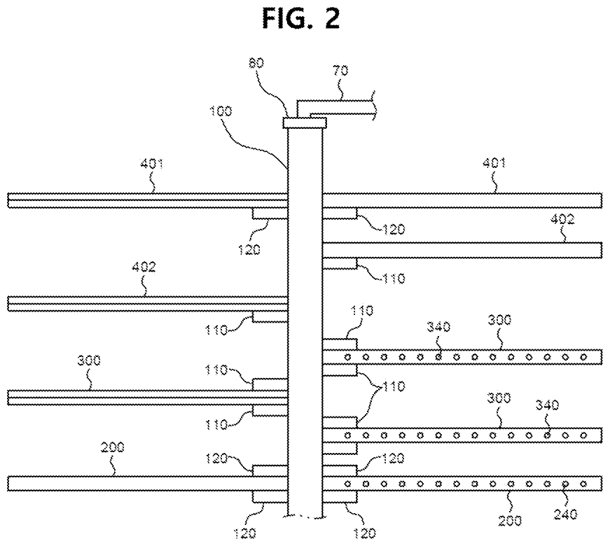

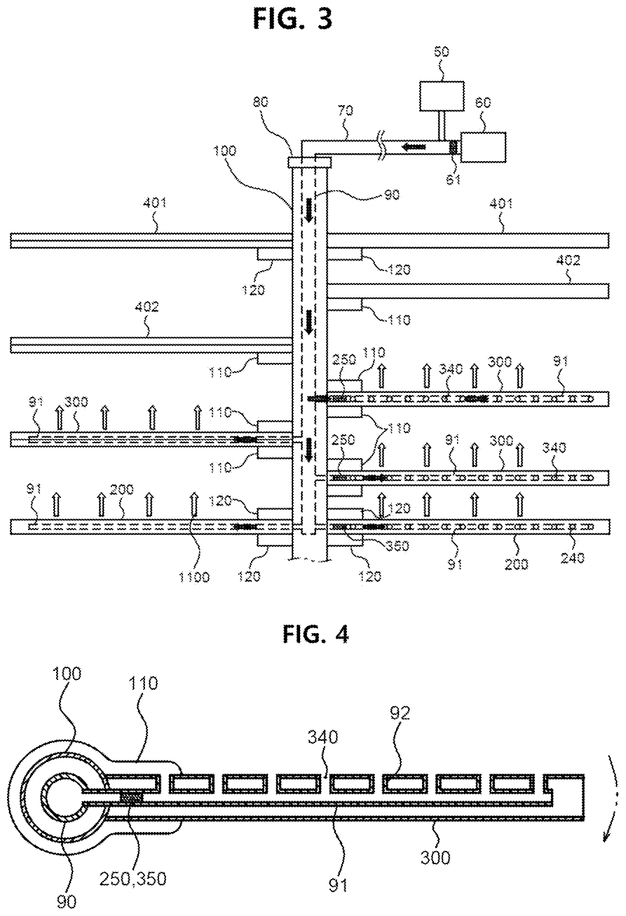

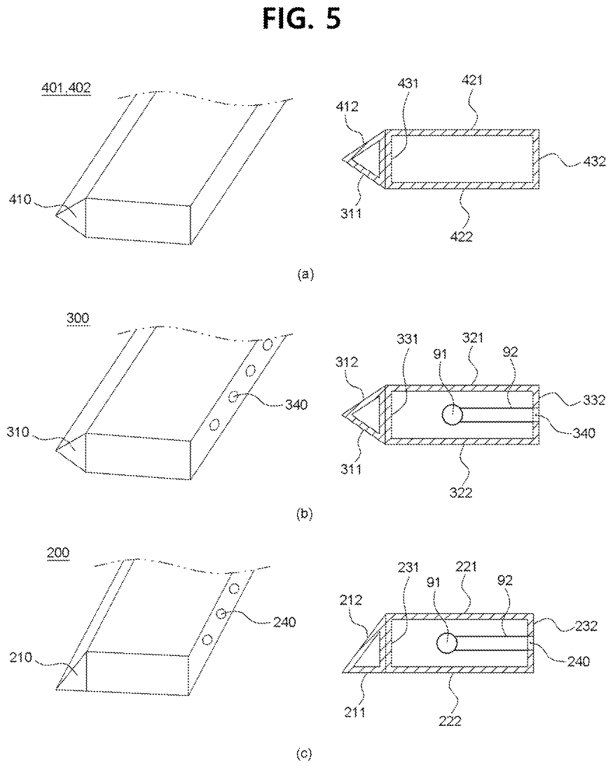

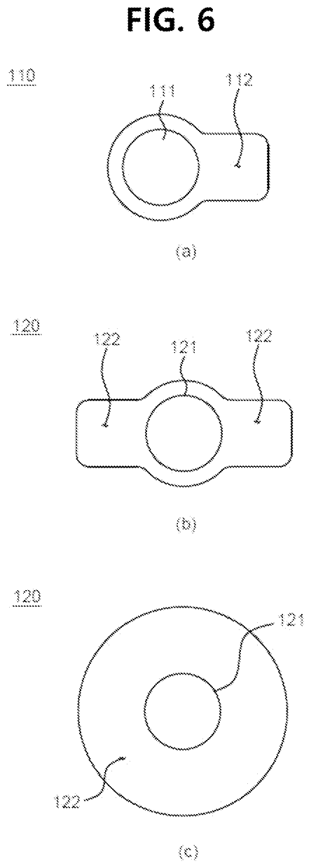

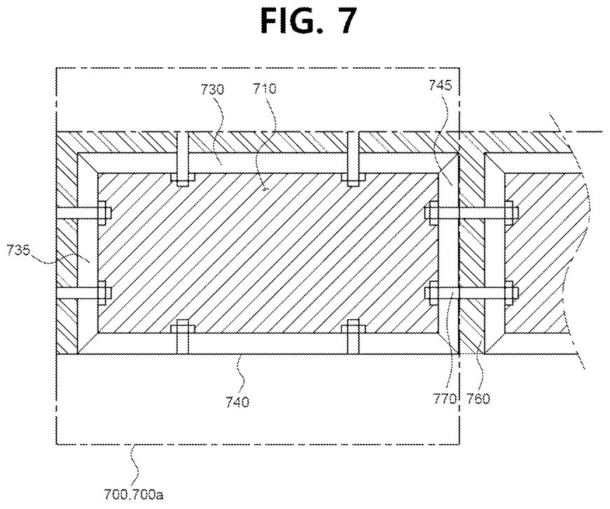

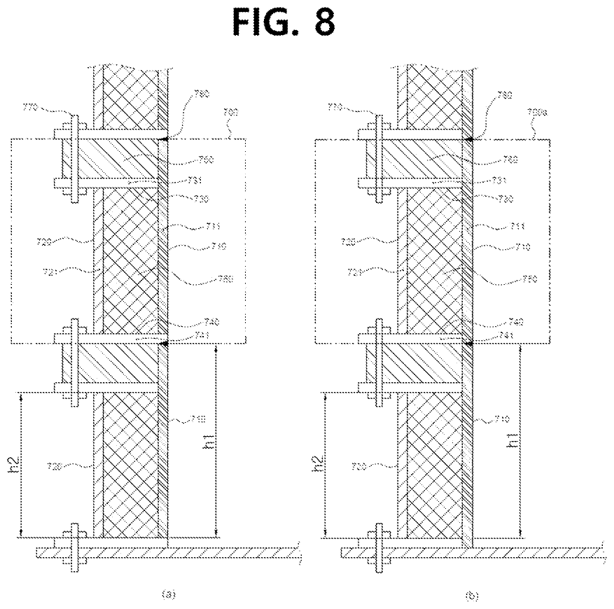

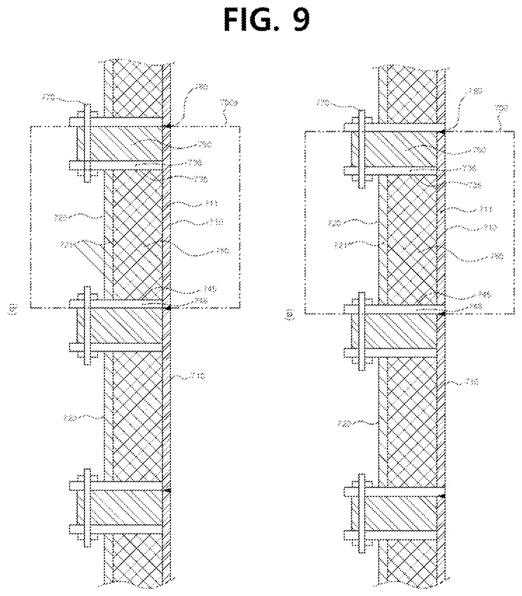

FIG. 1 is a cross-sectional view schematically illustrating an interior of a cylindrical shell-shaped fermentation tank in the high-speed dry/fermentation apparatus according to the first example embodiment. FIG. 2 is a front view schematically illustrating a stirring shaft and stirring blades according to the first example embodiment. FIG. 3 is a front view schematically illustrating a state in which an air supplier according to the first example embodiment is provided. FIG. 4 is a plan view schematically illustrating the state in which the air supplier according to the first example embodiment is provided. FIGS. 5A to 5C are perspective views and cross-sectional views schematically illustrating an upper stirring blade, a middle stirring blade, a lower stirring blade, respectively. FIGS. 6A to 6C is a plan view of a first bracket and a plan view of a second bracket according to the first example embodiment, and a plan view of a second bracket according to another example embodiment, respectively. FIG. 7 is an explanatory view illustrating a state in which one wall module 700 is coupled to the right side of another wall module 700. FIGS. 8A and 8B are partial vertical cross-sectional views of the high-speed organic waste dry/fermentation apparatus when a plurality of wall modules 700 are coupled to each other in a vertical direction to form an outer wall. FIGS. 9A and 9B are partial horizontal cross-sectional views of the highspeed organic waste dry/fermentation apparatus when the plurality of wall modules is coupled to each other in a horizontal direction to form the outer wall.

As illustrated in figures including FIG. 1, the organic waste dry/fermentation apparatus according to the first example embodiment produces dried/fermented organic matters by inputting moisture-rich organic wastes, such as livestock manure, sewage/wastewater sludge and remaining food and drink, into a cylindrical shell-shaped fermentation tank 10 of a drum shape and rotating a lower drive part to rotate a stirring shaft 100 vertically connected to the lower drive part and stirring blades coupled to the stirring shaft 100 at a right angle and to ferment organic wastes 1000 while stirring the organic wastes 1000.

In this case, the stirring shaft 100 is provided at the center of the cylindrical shell-shaped fermentation tank 10, and the stirring blades are supported at one end of the stirring shaft 100.

The stirring blades include a lower stirring blade 200 arranged at the lowermost stage, a middle stirring blade 300 arranged above the lower stirring blade 200, and an upper stirring blade 400 arranged above the middle stirring blade 300.

Further, the organic waste dry/fermentation apparatus according to the present disclosure is configured to prevent break of the stirring shaft and the stirring blades by differently arranging structures of the stirring blades 200, 300 and 400 according to an arrangement position and processing function of each of the stirring blades 200, 300 and 400.

Further, the upper stirring blade 400 includes a first-stage upper stirring blade 401 arranged at the uppermost stage, and a second-stage upper stirring blade 402 arranged just below the first-stage upper stirring blade 401 to have the same shape as that of the first-stage upper stirring blade 401.

Further, each of the first-stage upper stirring blade 401 and the second-stage upper stirring blade 402 are constituted with an upper front plate 431, an upper rear plate 432, an upper top plate 421, and an upper bottom plate 422 which are positioned in a traveling direction. The upper front plate 431 has an upper protrusion 410 for reducing a rotational resistance.

In addition, the lower stirring blade 200 and the middle stirring blade 300, which are arranged below the fermentation tank 10 and under significant load, are formed in the form of a frame in which a plurality of plate members is combined.

Further, the first-stage upper stirring blade 401 or the second-stage upper stirring blade 402, which are positioned above the fermentation tank 10 and receive a relatively smaller load than the lower stirring blade 200 and the middle stirring blade 300, are formed in the form of a frame in which a single plate member or a plurality of plate members are combined with each other such that structures of the stirring blades are formed differently depending on a magnitude of the load.

Further, each of the lower stirring blade 200 and the first-stage upper stirring blade 401 include two or more stirring blades which are provided at the same height in a symmetric relationship with a central line A of the stirring shaft 100.

Further, the middle stirring blade 300 and the second-stage upper stirring blade 402 may be provided one-by-one in a staggered manner with respect to the stirring shaft 100.

Further, the lower stirring blade 200 is constituted with a lower front plate 231, a lower rear plate 232, a lower top plate 221, and a lower bottom plate 222 which are positioned in a traveling direction. The lower front plate 231 has a lower protrusion 210 for reducing a rotational resistance.

Further, the lower protrusion 210 has the lower front plate 231 as a base, a fifth plate member 211 and a sixth plate member 212 as both sides. The fifth plate member 211 arranged parallel to the lower bottom plate 222 and the sixth plate member 212 is arranged obliquely to form a right triangle. This configuration reduces resistance to bias upward due to the dried/fermented organic matters deposited on the bottom of the fermentation tank 10 when the lower stirring blade 200 rotates.

In addition, the bottom rear plate 232 of the lower stirring blade 200 has a plurality of lower air holes 240 to provide external air to the organic waste 1000 when the lower stirring blade 200 rotates, thus promoting fermentation.

Further, the middle stirring blade 300 is constituted with a middle front plate 331, a middle rear plate 332, a middle top plate 321, and a middle bottom plate 322 which are positioned in the traveling direction. The middle front plate 331 has a middle protrusion 310 for reducing a rotational resistance.

In addition, the middle rear plate 332 of the middle stirring blade 300 has a plurality of middle air holes 340 to supply external air to the organic waste 1000 when the middle stirring blade 300 rotates, thus promoting fermentation.

Further, the middle protrusion 310 has the middle front plate 331 as a base, and the first plate member 311 and the second plate member 312 as both sides to form an isosceles tringle. In this case, a vertex at which the first plate member 311 and the second plate member 312 meet are positioned in the center of the middle front plate 331. This reduces a rotational resistance when the middle stirring blade 300 rotates.

Further, the upper protrusion 410 has the upper front plate 431 as a base, and a third plate member 411 and a fourth plate member 412 as both sides to form an isosceles tringle. In this case, a vertex at which the third plate member 411 and the third plate member 412 meet are positioned in the center of the upper front plate 431. This reduces a rotational resistance when the first-stage upper stirring blade 401 and the second-stage upper stirring blade 402 rotate.

Further, the air supplier for supplying the external air is connected to the lower air holes 240 and the middle air holes 340.

The air supplier includes an air compressor 50, a blower 60, an anti-backflow damper 61 provided in a conduit in front of the blower 60 to prevent backflow of high pressure during the operation of the air compressor 50, a first supply pipe 70 configured to move air supplied from the blower 60 therethrough, and a switch 80 provided inside the rotating stirring shaft 100 to supply the air supplied from the first supply pipe 70 in a fixed state to a second supply pipe 90 which is being rotated.

In addition, a third supply pipe 91 is provided inside the middle stirring blade 300 and inside the lower stirring blade 200 to supply the air supplied through the second supply pipe 90 to the lower air holes 240 and the middle air holes 340. A branch supply pipe 92 is branched at the third supply pipe 91 to supply the air to the lower air holes 240 and the middle air holes 340.

While supplying the external air from the above-described blower to the air supply pipe connected to the stirring blades 200 and 300 which are connected to the stirring shaft 100, an unexpected situation such power outage may occur. Due to such power outage, the organic waste 1000 inside the fermentation tank 10 may flow into the lower air holes 240 and the middle air holes 340 of the stirring blades and may cause a backward flow. To address this, an anti-backflow valve for lower stirring blade 250 and an anti-backflow valve for middle stirring blade 350 may be provided to block the third supply pipe 91.

The air compressor 50 is provided at a certain portion of the first supply pipe 70. When some of the lower air holes 240 and the middle air holes 340 are clogged, high-pressure air may be provided to open the clogged holes among the lower air holes 240 and the middle air holes 340.

Further, the stirring shaft 100 is provided with a supporting bracket for supporting one ends of the stirring blades. The brackets are provided to be coupled to the stirring shaft 100.

Further, the support bracket includes a first bracket 110 for supporting the middle stirring blade 300 and the second-stage upper stirring blade 402 provided in a staggered manner on the stirring shaft 100, and a second bracket 120 for supporting the lower stirring blade 200 and the first-stage upper stirring blade 401, which include a plurality of stirring blades provided at the same height on the stirring shaft 100.

Further, the first bracket 110 has a first through-hole 111 formed in the stirring shaft 100. A first supporting portion 112 is provided at one side of the first through-hole 111 to support the middle stirring blade 300 and the second-stage upper stirring blade 402.

Further, the second bracket 120 has a second through-hole 121 formed in the stirring shaft 100. Second supporting portions 122 are provided at both sides or an upper side of the second through-hole 121 to support the lower stirring blade 200 and the first-stage upper stirring blade 401. Further, the second brackets 120 are provided above and below the lower stirring blade 200, which is positioned below the fermentation tank 10 and under a significant load, to support the lower stirring blade 200.

Further, the first brackets 110 are provided above and below the middle stirring blade 300 to support the middle stirring blade 300. The first brackets 110 are provided above and below the second-stage upper stirring blade 402 to support the second-stage upper stirring blade 402.

Further, the first-stage upper stirring blade 401 is supported by the second brackets 120 provided above and below the first-stage upper stirring blade 40.

Further, the cylindrical shell-shaped fermentation tank 10 is formed by coupling a plurality of wall modules 700 to each other in vertical and horizontal directions.

In FIG. 7, one wall module 700 is illustrated to be provided on the right side of another wall module 700. The plurality of wall modules 700 are coupled to each other in the vertical and horizontal directions to form the cylindrical shell-shaped fermentation tank 10.

FIGS. 8A and 8B are partial vertical cross-sectional views illustrating states in which the plurality of wall modules 700 are coupled to each other in the vertical and horizontal directions to form an outer wall. FIGS. 9A and 9B are partial horizontal cross-sectional views thereof.

The same components in the partial vertical cross-sectional views illustrated in FIGS. 8A and 8B and the partial horizontal cross-sectional views illustrated in FIGS. 9A and 9B will be denoted by the same reference numerals.

Referring first to the partial vertical cross-sectional views illustrated in FIGS. 8A and 8B, one wall module 700 includes an inner wall 710 and an outer wall 720, and has a configuration in which a filling material 750 is injected between the inner wall 710 and the outer wall 720 to transfer a load of the inner wall 710 to the outer wall 720. This configuration forms a composite cross-sectional structure composed of the inner wall 710, the filling material 750 and the outer wall 720 to address the load caused inside the shell.

Further, the inner wall 710 is made of a stainless material and the outer wall 720 is made of steel. Assuming that a height of the inner wall 710 is h1 and a height of the outer wall 720 is h2, a relationship of h1>h2 is established.

A lower wall plate 740 and an upper wall plate 730 are provided to integrally form the inner wall 710 and the outer wall 720.

FIG. 8A illustrates one type of coupling fashion in which an upper surface of the lower wall plate 740 is connected to lower end portions of the inner wall 710 and the outer wall 720 to integrally form the inner wall 710 and the outer wall 720, an upper end portion of the outer wall 720 is coupled to a predetermined site on a lower surface of the inner wall 710, and one end portion of the upper wall plate 730 is coupled to a predetermined site on one surface of the inner wall 710.

FIG. 8B illustrates another type of coupling fashion in which the upper wall plate 730 and the inner wall 710 and the outer wall 720 are coupled to each other. The coupling fashion illustrated in FIG. 8B is the same as that illustrated in FIG. 8A except that an upper surface of the lower wall plate 740 is coupled to a lower end portion of the outer wall 720 and one end portion of the lower wall plate 740 is coupled to a lower portion of one surface of the inner wall 710. In this case, when side surface of the inner wall 710 are coupled to each other, transverse and longitudinal sizes of the inner wall 710 may be advantageous in determining a size of the wall of the fermentation tank 10.

That is, the configurations illustrated in FIGS. 8A and 8B are different from each other in that in FIG. 8B, the inner surface is fully formed of stainless steel as being connected only by the inner walls, and in FIG. 8A, the inner surface is formed of stainless steel and the end portion of the lower wall plate by connecting the inner walls with the end portions of the lower wall plate 740 interposed between the inner walls. However, such configurations may be changed in different designs depending on a field situation.

Referring to the partial horizontal cross-sectional views illustrated in FIGS. 9A and 9B, a left wall plate 745 and a right wall plate 735 are provided to integrally form the inner wall 710 and the outer wall 720 even in the traverse direction.

Here, in the following description, for the clarification of a direction relationship described in FIGS. 8A and 8B, the left side of FIGS. 9A and 9B is defined as an upper side and the right side thereof is defined as a lower side (that is, states in which the views of FIGS. 9A and 9B are rotated clockwise by 90 degrees).

FIG. 9A illustrates one type of coupling fashion in which an upper surface of the right sidewall plate 745 (a left surface as seen in FIGS. 9A and 9B) is connected to lower end portions of the inner wall 710 and the outer wall 720 to integrally form the inner wall 710 and the outer wall 720, an upper end portion of the outer wall 720 is coupled to a predetermined site of a lower surface of the left wall plate 735, and one end portion of the left wall plate 735 is coupled to a predetermined site of one surface of the inner wall 710.

FIG. 9B illustrates another type of coupling fashion in which the left wall plate 735, the inner wall 710 and the outer wall 720 are coupled to each other, which is similar to that illustrated in FIG. 9A. However, the coupling fashion illustrating in at illustrating in FIG. 9B is different from that illustrated in FIG. 9A in that an upper surface of the right wall plate 745 is coupled to a lower end portion of the inner wall 710, and one end portion of the right wall plate 745 is coupled to a lower portion of one surface of the outer wall 720. In this case, when side surfaces of the inner wall 710 are coupled to each other, transverse and longitudinal sizes of the inner wall 710 may be advantageous in determining the size of the wall of the fermentation tank 10. That is, in FIG. 9B, the inner surface is fully formed of stainless steel as being connected only by the inner walls, whereas in FIG. 8A, the inner surface is formed of stainless steel and the end portion of the lower wall plate by connecting the end portions of the right wall plate 745 between the inner walls. However, such configurations may be changed in different designs depending on a field situation.

Thus, a cross-section which makes up the outline of the wall module 700 is formed by the first cross-section 711 of the inner wall 710, the second cross-section 721 of the outer wall 720, the third cross-section 731 of the upper wall plate 730, the fourth cross-section 741 of the lower wall plate 740, the fifth cross-section 736 of the left wall plate 735, and the sixth cross-section 746 of the right wall plate 746. Thus, the wall module 700 has a strong structure. The filling material 750 is provided between the inner wall 710 and the outer wall 720 so that both an insulation function of coping with an external temperature and a load transfer function of transferring, to the outer wall 720, a hoof tension of the inner wall 710 which receives previously a hoof tension of the organic waste inside the drum-shaped cylindrical shell dry/fermentation tank, are performed.

Further, the outer wall 720 is formed of steel and the inner wall 710 is formed of a stainless material. The filling material 750 is provided between the outer wall 720 and the inner wall 710.

Thus, the inner wall 710 is formed of stainless steel to cope with corrosion due to the organic waste which flows into the cylindrical shell-shaped dry/fermentation tank 10. The filling material 750 having a function of transferring an internal load to the outside is provided between the outer wall 720 and the inner wall 710. Thus, the inner wall 710 and the outer wall 720 constitutes a composite cross-section to cope with a hoof tension corresponding to an amount of the organic waste input into the tank. This enhances a durability of the drum-shaped cylindrical shell dry/fermentation tank 10 and increases a lifespan thereof. Even in a case where a capacity of the drum-shaped cylindrical shell dry/fermentation tank 10 is increased, the drum-shaped cylindrical shell dry/fermentation tank 10 may secure all the durability, corrosion resistance and economics with the composite cross-section.

That is, by making the material of the inner wall 710 and the outer wall 720 to have a double structure according to a contact site with the organic waste 1000 and providing the filling material having the insulation function of coping with the external temperature and the structural function of transferring the internal load to the outside, it is possible to increase the durability and the corrosion resistance and increase an usage lifespan of the drum-shaped cylindrical shell dry/fermentation tank 10.

Further, in the plurality of wall modules 700, one wall module positioned at a lower side is referred to as a first wall module, and a wall module provided just above the first wall module is referred to as a second wall module. In this case, an upper wall plate of the first wall module and a lower wall plate of the second wall module are arranged to face each other at a distance.

Further, when the first wall module and the second wall module are coupled to each other, the inner wall of the first wall module and the inner wall of the second wall module are arranged in a straight line with each other.

Further, the coupling inside the drum-shaped cylindrical shell dry/fermentation tank 10 may be performed by a welding 780 and the coupling outside the drum-shaped cylindrical shell dry/fermentation tank 10 may be performed by coupling the upper wall plate 730 of the first wall module and the lower wall plate 740 of the second wall module to each other using a bolt 770 in a state where a spacer 760 is sandwiched between the upper wall plate 730 and the lower wall plate 740.

In addition, in a case of a horizontal wall module 600 of the plurality of wall modules 700, one wall module positioned on the left side in the horizontal direction is referred to as a third wall module, and a wall module provided on the right side of the third wall module is referred to as a fourth wall module. In this case, a right wall plate of the third wall module and a left wall plate of the fourth wall module are arranged to face each other at a distance.

Further, when the third wall module and the fourth wall module are coupled to each other, the inner wall 610 of the third wall module and the inner wall of the fourth wall module are arranged in a straight line with each other.

Further, the coupling inside the drum-shaped cylindrical shell dry/fermentation tank 10 may be performed by the welding 780 and the coupling outside the drum-shaped cylindrical shell dry/fermentation tank 10 may be performed by coupling the left wall plate 735 of the third wall module and the right wall plate 745 of the fourth wall module to each other using the bolt 770 in a state where the spacer 760 is sandwiched between the left wall plate 735 and the right wall plate 745.

### Second Example Embodiment

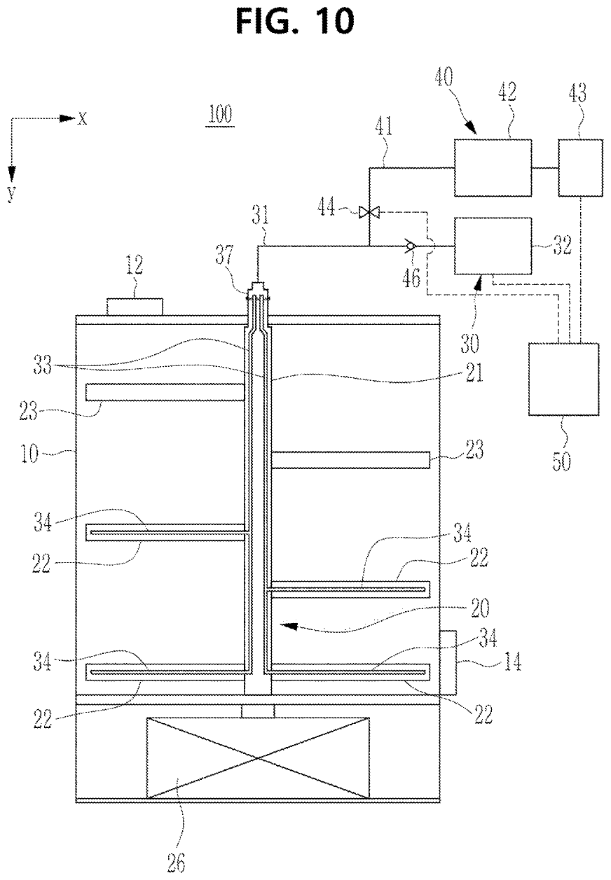

A configuration of a high-speed organic waste dry/fermentation apparatus according to a second example embodiment will be described below with reference to FIGS. 10 to 13.

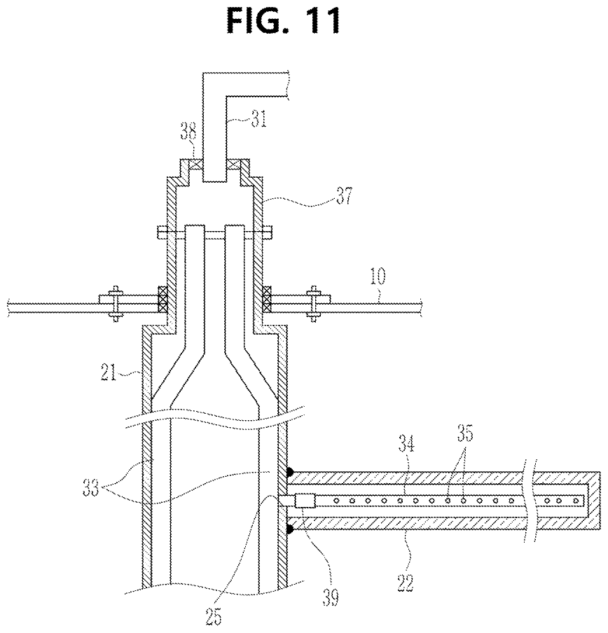

FIG. 10 illustrates an overall configuration of the high-speed organic waste dry/fermentation apparatus according to the second example embodiment, and FIGS. 11 and 12 illustrate in detail a portion of the configuration of the high-speed organic waste dry/fermentation apparatus.

As illustrated in FIG. 10, the high-speed organic waste dry/fermentation apparatus of this example embodiment (hereinafter referred to as a fermentation apparatus 100) may include the fermentation tank 10 arranged to be perpendicular to the ground and having an internal organic-waste accommodation space in which a dry/fermentation treatment on the organic waste is performed, a stirrer 20 provided in the fermentation tank 10 to stir excretion introduced into the fermentation tank 10, and an air supplier 30 for supplying air into the fermentation tank 10 using injection stirring blades 23 of the stirrer 20.

The high-speed organic waste dry/fermentation apparatus 1 of this example embodiment is capable of drying and fermenting the organic waste through organic decomposition of aerobic microorganisms by supplying the external air while stirring the organic waste introduced into the fermentation tank 10 with the stirrer 20.

The fermentation tank 10 has an empty cylindrical cross-sectional structure. In this example embodiment, the fermentation tank 10 may have a vertical structure in which the fermentation tank 10 is installed vertically on the ground.

In the following description, in FIG. 10, a y-axis direction in a state in which the fermentation tank 10 is provided vertically on the ground is referred to as an up-down direction or a vertical direction, a direction oriented upward in the y-axis direction is referred to as above or an upper portion, and a direction oriented downward in the y-axis direction is referred to as below or a lower portion.

An inlet 12 may be provided on the upper portion of the fermentation tank 10 to introduce the organic waste into the fermentation tank 10 therethrough. An outlet 14 may be provided on the lower portion of the fermentation tank 10 to discharge fermented compost therethrough. The size or structure of the fermentation tank 10 may be modified in various forms.

The stirrer 20 of this example embodiment may include a stirring shaft 21, injection stirring blades 22 and the stirring blades 23 provided on the stirring shaft 21, and a driver 23 for rotating the stirring shaft 21.

The stirring shaft 21 is arranged in the center of the fermentation tank 10 and extends up and down along the vertical direction. Both tips of the stirring shaft 21 may be rotatably provided on upper and lower ends of the fermentation tank 10 via, for example, ball bearings.

The driver 23 may be connected to one end of the stirring shaft 21 to rotatably drive the stirring shaft 21. In this example embodiment, the driver 23 may be provided below the fermentation tank 10 and may be connected to the lower end of the stirring shaft 21. For example, the driver 23 may have a structure using an expansion and contraction drive force of a drive cylinder or a rotational force of a motor.

The stirring blades 23 and the injection stirring blades 22 may be provided at intervals along the stirring shaft 21.

In this example embodiment, the stirring blades 23 may be positioned above the injection stirring blades 22.

Unlike the injection stirring blades 22, the stirring blades 23 are not connected to the air supplier 30 and thus has a structure that does not injection air. The stirring blades 23 serve to stir the organic waste while rotating with the drive of the stirring shaft 21.

The stirring blades 23 may be arranged in a staggered manner along the stirring shaft 21. Further, stirring blades 23 may be arranged at intervals along a circumferential direction of the stirring shaft 21. The arrangement position or number of the stirring blades 23 may be variously changed.

The injection stirring blades 22 are provided to inject the air downward of the stirring blade. A plurality of injection stirring blades 22 may be provided at vertical intervals along the stirring shaft 21.

As illustrated in FIG. 10, in this example embodiment, the injection stirring blades 22 may be configured to be provided at upper, middle and lower positions at intervals along the stirring shaft 21, respectively. The number of injection stirring blades 22 provided on the stirring shaft 21 is not limited to the above but may be variously changed.

In addition, injection stirring blades 22 may be arranged at the upper, middle and lower positions at intervals at a predetermined angle along the circumferential direction of the stirring shaft 21. For example, as illustrated in FIG. 10, two or more injection stirring blades may be arranged at the lowermost position of the stirring shaft 21 along the circumferential direction. This makes it possible to increase the stirring force and injection a relatively large amount of air from the lower portion of the fermentation tank 10 to increase dry/fermentation efficiency.

One end of each injection stirring blade 22 is provided to be perpendicular to the stirring shaft 21 and the other end thereof extends toward the inner surface of the fermentation tank 10. The injection stirring blades 22 may be fixedly provided to the stirring shaft 21 by welding.

The stirring shaft 21 and the injection stirring blades 22 may have a hollow pipe structure with an empty interior. Thus, a separate pipe structure for supplying external air may be provided inside the stirring shaft 21 and the injection stirring blades 22. In a lateral surface of the stirring shaft 21, a hole 25 through which the stirring shaft 21 and the interior of each injection stirring blade 22 are in communication with each other is formed to correspond to the arrangement position of each injection stirring blade 22.

As the driver 23 operates, the stirring shaft 21 is rotated, and the stirring blades 23 and the injection stirring blades 22 provided on the stirring shaft 21 are also rotated. Thus, the organic waste filled into the fermentation tank 10 is stirred.

Each stirring blade 23 or each injection stirring blade 22 may be provided with a protrusion 27 for resistance reduction. Hereinafter, the protrusion 27 provided on each injection stirring blade 22 will be described as an example. This holds true in each stirring blade 23.

The protrusion 27 is provided on a front side along a rotational direction of the injection stirring blade 22, on an opposite side to a surface on which a discharge port 36 is formed. The protrusion 27 is formed continuously along the injection stirring blade 22. With this configuration, the protrusion 27 provided on the front side when the injection stirring blade 22 rotates reduces the resistance of the organic waste.

The protrusion 27 has a structure of a triangular cross-sectional shape that becomes sharper toward the tip. In this example embodiment, the protrusion 27 may be formed to have a cross-sectional structure in the form of an isosceles triangle or a right-angle triangle. For example, the protrusion 27 may be formed by bonding two plates at a certain angle or bending one plate at a certain angle, and bonding the same to the injection stirring blade 22.

This makes it possible to reduce the rotational resistance exerted on the injection stirring blades by the protrusion arranged at the front side along the rotational direction at the time of rotation of the injection stirring blades. Therefore, it becomes possible to reduce a torque of the driver and thus to save a driving energy (electric energy).

While the injection stirring blades 22 rotate inside the organic waste, the external air may be injected toward the organic waste with the injection stirring blades 22 by the air supplier 30.

The air supplier 30 may injection the air with each injection stirring blade while minimizing a loss of pressure. This makes it possible to efficiently supply the air or high-pressure compression air supplied from the air supplier 30 toward an end of each injection stirring blade 22 in an individual manner.

To this end, the air supplier 30 of this example embodiment may include: an external air supplier; a first air supply pipe 31 provided in the external air supplier and connected to the tip pf the stirring shaft 21 to supply the air; a plurality of second air supply pipes 33 branched at the first air supply pipe 31 and extending along the interior of the stirring shaft 21 to supply the air toward the injection stirring blades 22; a third air supply pipe 34 provided inside each injection stirring blade 22 and connected to one second air supply pipe 33 extending to each the injection stirring blade 22; and at least one or more injection nozzles 35 provided along the third air supply pipe 34 to injection the air via the discharge ports 36 formed in each injection stirring blade 22.

Thus, the air supplied through the first air supply pipe 31 may be divided by the second air supply pipes 33, moved while being divided along the stirring shaft 21, and supplied to each of the injection stirring blades 22. A structure in the related art does not supply air while being divided along the stirring shaft. This makes it difficult to properly supply the air through each injection stirring blade.

The external air supplier may be understood as a device which is driven by electric power to forcibly supply the external air via the first air supply pipe, such as a blower or a compressor.

The external air supplier of this example embodiment includes a blower 32 provided in the first air supply pipe 31 to supply the external air, and a compression air supplier 40 connected to the first air supply pipe 31 to supply high-pressure compression air, and is configured to selectively supply the external air or the high-pressure compression air.

Further, the air supplier 30 may further include a controller 50 that controls the supply of the external air by the blower 32 and the supply of the compression air by the compression air supplier 40. For example, the controller 50 may appropriately control the supply, supply amount or the like of the external air or the high-pressure compression air depending on an operation condition such as a viscosity of the organic waste.

The blower 32 is connected to the first air supply pipe 31 to supply the external air to the first air supply pipe 31. In this example embodiment, the blower 32 may have a structure of supplying the external air at all times. With the drive of the blower 32, the external air is continuously supplied to the third air supply pipe 34 of each injection stirring blade 22 via the first air supply pipe 31 and each second air supply pipe 33.

In this example embodiment, the compression air supplier 40 may have a structure for supplying the high-pressure compression air via the first air supply pipe 31 in an intermittent manner or at set time intervals as needed.

To this end, the compression air supplier 40 may include a compression pipe 41 connected to the first air supply pipe 31, a compressor 42 connected to the compression pipe 41 to supply the compression air, an air tank 43 which stores the compression air, an opening/closing valve 44 for opening and closing the compression pipe 41, and a check valve 46 provided in the first air supply pipe 31 at a front end of the blower 32 to prevent the compression air from flowing back to the blower 32.

The compressor 42 compresses the external air and stores the same in the air tank 43. The high-pressure compression air stored in the air tank 43 is supplied to the first air supply pipe 31 via the compression pipe 41.

The compression pipe 41 connects the air tank 43 and the first air supply pipe 31. The opening/closing valve 44 for opening and closing the compression pipe 41 is provided on one side of the compression pipe 41.

The opening/closing valve 44 may be controlled by the controller 50.

When the opening/closing valve 44 is open, the compression pipe 41 and the first air supply pipe 31 are connected to each other so that the high-pressure compression air stored in the air tank 43 is supplied to the first air supply pipe 31 via the compression pipe 41.

The check valve 46 is provided in a front end of the blower 32. While the high-pressure compression air is supplied from the compression pipe 41 to the first air supply pipe 31 with the operation of the opening/closing valve 44, the compression air may be prevented from flowing back to the blower 32. This makes it possible to prevent the blower from being damaged by the high-pressure compression air.

As described above, it becomes possible to selectively supply, by the blower 32, the high-pressure compression air or the external air to each injection stirring blade 22 depending on the set time intervals or the conditions as needed.

With this configuration, the air is divided in the second air supply pipes 33 and individually supplied to each injection stirring blade 22 connected to the second air supply pipes 33, which makes it possible to smoothly supply the air to the end of each injection stirring blade 22 while minimizing a loss of pressure.

Thus, it is possible to supply the air into the fermentation tank in a continuous and stable manner during the operation of the apparatus, and to fundamentally avoid clogging of the injection nozzles 35 provided in each injection stirring blade 22.

With the drive of the air supplier 30, the air is continuously supplied to the third air supply pipe 34 of each injection stirring blade 22 via the first air supply pipe 31 and each second air supply pipe 33.

The first air supply pipe 31 may have a pipe structure for fluid transfer and may be connected to an upper end of the stirring shaft 21 and the plurality of second air supply pipes 33 provided in the stirring shaft 21.

An air distribution chamber 37 may be provided on the upper end of the stirring shaft 21 to connect the first air supply pipe 31 and the second air supply pipes 33.

As illustrated in FIG. 11, the air distribution chamber 37 is provided on the stirring shaft 21 and is in communication with the plurality of second air supply pipes 33 at a lower portion of the air distribution chamber 37. Further, the first air supply pipe 31 may be rotatably provided while maintaining an airtight state at the upper portion of the air distribution chamber 37. A sealing portion 38 may be provided between the first air supply pipe 31 and the air distribution chamber 37 to ensure airtight and smooth rotation. A piping hydraulic holder or a retainer seal may be used as the sealing portion 38.

The air distribution chamber 37 has a chamber structure with an internal space, and connects the first air supply pipe 31 and the plurality of second air supply pipes 33. A size of the internal space of the air distribution chamber 37 may be variously changed.

The air supplied via the first air supply pipe 31 flows to the internal space of the air distribution chamber 37. Since the plurality of second air supply pipes 33 are in communication with the air distribution chamber 37, the air flows to the plurality of second air supply pipes 33 while being divided to the plurality of second air supply pipes 33.

As described above, by providing the air distribution chamber 37, it becomes possible to evenly divide and supply the air supplied from the first air supply pipe 31 to the plurality of second air supply pipes 33.

Each second air supply pipe 33, which has a pipe structure for fluid transfer, divides the air supplied via the first air supply pipe 31 and supplies the same to each injection stirring blade 22.

The second air supply pipe 33 is provided inside the stirring shaft 21 of the hollow structure. The upper end of each second air supply pipe 33 is in communication with the air distribution chamber 37 and thus is connected to the first air supply pipe 31. A lower end of each second air supply pipe 33 extends downward along the stirring shaft 21, and is connected to the third air supply pipes 34 provided in the injection stirring blades 22 via holes 25 formed in the stirring shaft 21.

Each second air supply pipe 33 may be provided along an inner peripheral surface of the stirring shaft 21 while being in contact with the inner peripheral surface. Accordingly, the plurality of second air supply pipes 33 may be provided inside the stirring shaft 21 in a more stable manner.

In this example embodiment, the second air supply pipes 33 may be provided to correspond to the number of injection stirring blades 22 arranged along the circumferential direction of the stirring shaft 21. At least one or more injection stirring blades are connected to each second air supply pipe 33 while being arranged up and down at the same position along the circumferential direction of the stirring shaft 21. For example, in a case of a structure in which three injection stirring blades are arranged at an angle of 120 degrees along the circumferential direction of the stirring shaft 21, three second air supply pipes 33 may also be provided to correspond to the three injection stirring blades. Each of the three second air supply pipes 33 extends vertically downward along the stirring shaft 21, and is branched into the third air supply pipes 34 of the injection stirring blades 22 arranged up and down at respective positions.

Thus, the air supplied via the first air supply pipe 31 may be divided to the second air supply pipes 33 and be supplied to the injection stirring blades 221 connected to each of the second air supply pipes 33. Accordingly, it is possible to send the air supplied via the first air supply pipe to the end of each injection stirring blade 22 while minimizing a loss of energy.

As described above, in this example embodiment, since separate second air supply pipes 33 for supplying the air to each injection stirring blade 22 are provided inside the stirring shaft 21, it is possible to injection, via the third air supply pipes 34, the external air from the blower 32 or the high-pressure compression air from the compressor 42 even with less energy.

Each third air supply pipe 34, which has a pipe structure for fluid transfer, is connected to the second air supply pipes 33 to injection the air supplied via the second air supply pipes 33 to the outside via the injection stirring blades 22.

The third air supply pipes 34 are provided separately in the internal spaces of the injection stirring blades 22. This makes it possible to flow the air through each third air supply pipe 34 and injection the air through the injection nozzles 35 provided in each third air supply pipe 34.

Thus, even if the size of the internal space of the injection stirring blade 22 becomes larger, it is possible to injection the air via the third air supply pipe 34 while maintaining an injection pressure and an injection flow rate without a loss of pressure.

Accordingly, it is possible to more efficiently supply the air into the fermentation tank 10, and to freely change the size of the injection stirring blades 22 depending on apparatus design conditions, operation environment conditions, or the like. For example, the size of the injection stirring blades may be set to be sufficient to stir highly viscous organic waste. Even if the size of the injection stirring blades becomes larger, the air is supplied via the third air supply pipe. Thus, no a loss of pressure occurs.

In the related art, since the external air is supplied to the internal space of the injection stirring blade in a simple manner, it was difficult to efficiently injection the air due to a loss of pressure. In addition, when the size of the injection stirring blades is increased to correspond to the highly viscous waste, the loss of pressure further becomes larger and a greater amount of energy is required. This makes it difficult to increase the size of the injection stirring blades.

In addition, the stirring blades are typically provided in a direction perpendicular to the stirring shaft to supply external air through the hollow stirring shaft and discharge ports of hollow injection stirring blades. Such a structure was developed for a low-pressure low-speed blower to treat low-viscosity organic waste. However, when the air is supplied at a low pressure and low speed, the external air is unlikely to be supplied, which is not sufficient to treat the high-viscosity organic waste.

In this example embodiment, the plurality of second air supply pipes 33 are provided and the third air supply pipe 34 is provided inside each injection stirring blade 22 to be connected to each second air supply pipe 33. Thus, the injection stirring blades 22 may be easily provided on the stirring shaft 21. This will be described again later.

The structures of the third air supply pipes 34 provided in the injection stirring blades 22 is the same.

A plurality of injection nozzles 35 is arranged along the third air supply pipe 34. The injection nozzles 35 are connected to respective discharge ports 36 formed in the injection stirring blade 22. Thus, the air injected from the injection nozzles 35 of the injection stirring blade 22 may be injected to the outside via the discharge ports 36.

In this example embodiment, the first air supply pipe 31, the second air supply pipes 33 and the third air supply pipes 34 may have structures having different inner diameters to supply the air while minimizing a loss of pressure with less energy. That is, the inner diameters of the first air supply pipe 31, the second air supply pipes 33 and the third air supply pipes 34 becomes smaller sequentially toward in an air supply direction.

The inner diameter of each second air supply pipe 33 is smaller than that of the first air supply pipe 31. With this structure, even if the air supplied at a predetermined pressure and flow rate from the first air supply pipe 31 is divided and supplied to the second air supply pipes 33, the air may be supplied to each injection stirring blade 22 while maintaining the predetermined pressure and flow rate.

The inner diameter of the third air supply pipe 34 is smaller than that of the second air supply pipe 33. With this structure, even if the plurality of injection nozzles 35 are formed in the second air supply pipe 33, the air supplied to the second air supply pipe 34 may be injected from a calculated flow rate and pressure via each injection nozzle 35.

Thus, according to this example embodiment, it is possible to efficiently supply the air from the first air supply pipe 31 to each injection stirring blade 22, which is an end member, with less energy (flow rate and flow velocity) while suppressing the loss of energy. This makes it possible to maximize an injection pressure and injection flow rate of the air which is injected finally from the discharge ports 36 of the injection stirring blade 22.

Even if dozens to hundreds of injection nozzles are provided in the entire injection stirring blades as described above, it becomes possible to inject the air from each injection nozzle 35 at a desired flow rate and flow velocity.

Further, it is possible to inject the air through the injection stirring blades 22 without a loss of energy or a loss of pressure, thus simplifying specifications of the blower 32 and the compressor 42 of the compression air supplier 40. This reduces manufacturing costs to ensure price competitiveness.

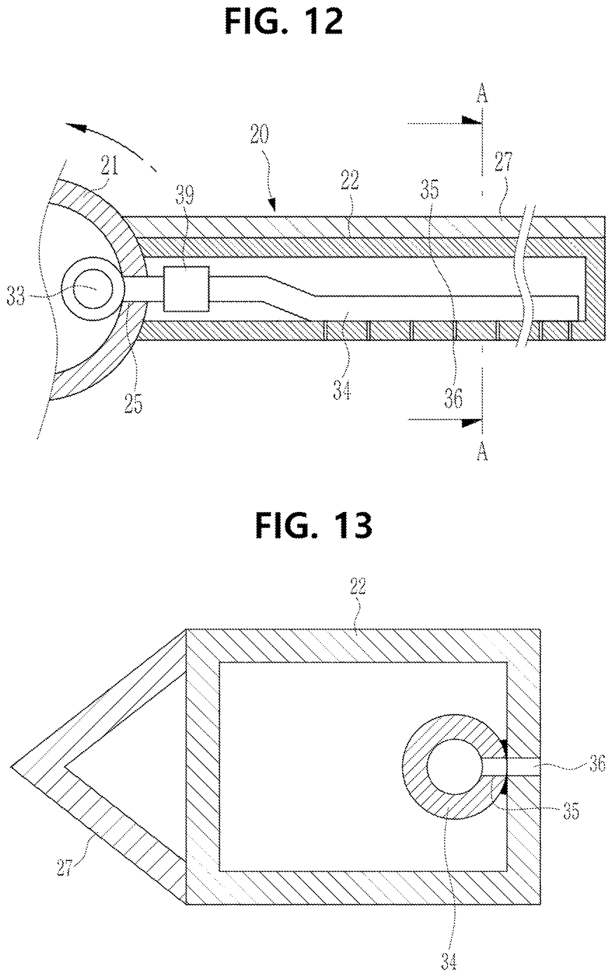

The third air supply pipe 34 may be fixedly provided inside the injection stirring blade 22 to form one unit. As illustrated in FIGS. 12 and 13, the third air supply pipe 34 is fixedly provided inside the injection stirring blade 22.

As an example, the third air supply pipe 34 may be provided along an inner surface of the injection stirring blade 22 while being fixed by a welding, a fixing bracket or the like on a surface in which the discharge ports 36 of the injection stirring blade 22 is formed. Therefore, the discharge ports 36 formed in the injection stirring blade 22 and the injection nozzles 35 provided in the third air supply pipe 34 may be directly connected to each other. Accordingly, the air supplied to the third air supply pipe 34 may be injected through the injection nozzles 35 and may be injected to the outside directly via the discharge ports 36 without a loss of flow rate or pressure.

Further, the protrusion 27 is provided in the injection stirring blade 22. Thus, even if the third air supply pipe 34 is provided to be biased to the surface in which the discharge ports 35 are formed, the center of gravity of the injection stirring blade 22 is not biased toward the discharge ports 35. That is, since the third air supply pipe 34 is provided on one side with reference to a central portion of the injection stirring blade 22, and the protrusion 27 is provided on the opposite side, weights may be balanced. Thus, the injection stirring blades 22 may be rotated while minimizing the twist by itself.

A connector 39 may be provided between the third air supply pipe 34 and the second air supply pipe 33 to selectively connect the third air supply pipe 34 and the second air supply pipe 33.

The connector 39 may be provided at each of tips of the third air supply pipe 34 and the second air supply pipe 33, and may have a coupling structure in which male and female portions are engaged with each other and thus they are connected to or separated from each other in one touch manner. The connector 39 may have any structure as long as it can connect and separate the tips of the third air supply pipe 34 and the second air supply pipe 33 to and from each other.

With this configuration, the injection stirring blades 22, which constitutes one unit together with the third air supply pipe 34, may be more easily provided on the stirring shaft 21. That is, when fixedly installing the injection stirring blade 22 on the stirring shaft 21, the second air supply pipe 33 of the stirring shaft 21 and the third air supply pipe 34 of the injection stirring blade 22 may be easily connected to each other by the connector 39.

As described above, the plurality of second air supply pipes 33 are provided individually to correspond to the arrangement of the injection stirring blades 22 along the circumferential direction of the stirring shaft 21, and the connector 39 is provided in each injection stirring blade 22 to correspond to the hole 25 around which each injection stirring blade 22 is provided in the vertical direction.

With this configuration, an operator can easily connect the third air supply pipe 34 to the second air supply pipe 33 by fastening the connector 39 of the third air supply pipe 34 provided in the injection stirring blade 22 to the connector 39 provided in the second air supply pipe 33. In this state, the injection stirring blade 22 may be easily installed on the stirring shaft 31 by fixing the injection stirring blade 22 to the stirring shaft 31 by welding.

The following describes the actions of this example embodiment.

A configuration in which the high-speed organic waste dry/fermentation apparatus 1 of this example embodiment supplies air via the blower 32 and the compressor 42 will be described below as an example.

The organic waste is introduced into the fermentation tank 10. As the high-speed organic waste dry/fermentation apparatus 1 operates, the stirring shaft 21 is rotated and the organic waste is stirred by the stirring blades 22. In this situation, the external air is supplied toward the organic waste through the stirring blades 22.

The controller 50 may control the blower 32 or the compressor 42 to supply the external air or the high-pressure compression air according to the drive conditions of the high-speed organic waste dry/fermentation apparatus 1 or a fermentation state of the organic waste.

The opening/closing valve 44 is operated based on a signal from the controller 50 so that the external air from the blower 32 or the high-pressure compression air from the compressor 42 is selectively supplied via the first air supply pipe 31.

When the opening/closing valve 44 of the compression pipe 41 is closed, the external air from the blower 32 is supplied to the first air supply pipe 31. The external air is divided to the plurality of second air supply pipes 33 and is supplied to each injection stirring blade 22 connected to each second air supply pipe 33.

The divided external air flowing through each second air supply pipe 33 is supplied to the third air supply pipe 34 connected to the second air supply pipe 33, and is injected through the injection nozzles 35 of the third air supply pipe 34. The air injected through the injection nozzles 35 is injected to the outside via the discharge ports 36 of each injection stirring blade 22 and is supplied toward the organic waste.

As the blower 32 continues to operate, air is continuously supplied into the third air supply pipe 34 at a constant pressure, and may be continuously injected to the outside via the discharge ports 36 of each injection stirring blade 22.

In this state, the controller 50 may control the compression air supplier 40 to inject the high-pressure compression air.

When the opening/closing valve 44 of the compression pipe 41 is open based on a signal from the controller 50, the high-pressure compression air stored in the air tank 43 is supplied to the first air supply pipe 31.

The high-pressure compression air is divided to the plurality of second air supply pipes 33 connected to the first air supply pipe 31 and is supplied to each injection stirring blade 22. The high-compression compression air may be evenly distributed to each injection stirring blade 22 through the plurality of second air supply pipes 33.

The high-pressure compression air supplied to each second air supply pipe 33 is supplied to the third air supply pipe 34 connected to each second air supply pipe 33, and is injected through the injection nozzles 35 of the third air supply pipe 34. Thus, the high-pressure compression air is injected to the outside via the discharge ports 36 of each injection stirring blade 22 connected to the injection nozzles 35.

The high-pressure compression air may be injected deeply to the high-viscosity organic waste, which increases efficiency of air supply.

As described above, according to the high-speed organic waste dry/fermentation apparatus 1 of this example embodiment, it is possible to dry and ferment the organic waste in a more efficient manner by injecting the high-pressure compression air as needed while continuously injecting the external air by the blower 32.

Further, by supplying the high-pressure compression air, it is possible to prevent the injection nozzles 35 or the discharge ports 36 of the injection stirring blades 22 from clogging.

While the exemplary example embodiments of the present disclosure have been described as above, various modifications and other example embodiments may be made by those skilled in the art. Such modifications and other example embodiments are contemplated and included in the appended claims and will not depart from the true spirit and scope of the present disclosure.

1. A high-speed organic waste dry/fermentation apparatus for producing a dried/fermented organic matter by rotating a stirring shaft coupled vertically to a lower driver and a stirring blade coupled at a right angle to the stirring shaft with a rotation of the lower driver, stirring the moisture-rich organic waste including livestock manure, sewage/waste water sludge or remaining food, which is inputted into a drum-shaped cylindrical shell fermentation tank, and fermenting the moisture-rich organic waste,
wherein the stirring shaft is provided in a central portion of the drum-shaped cylindrical shell-shaped dry/fermentation tank, one end of the stirring blade is supported by the stirring shaft,
wherein the stirring blade includes a lower stirring blade arranged at a lowermost end, a middle stirring blade arranged above the lower stirring blade, and an upper stirring blade arranged above the middle stirring blade, and
wherein the lower stirring blade, the middle stirring blade and the lower stirring blade are arranged in different structures according to arrangement positions and processing functions of the lower stirring blade, the middle stirring blade and the lower stirring blade.

2. The high-speed organic waste dry/fermentation apparatus of claim 1, wherein the upper stirring blade includes a first-stage upper stirring blade arranged at an uppermost end, and a second-stage upper stirring blade just below the first-stage upper stirring blade and having a shape identical to a shape of the first-stage upper stirring blade,
wherein the lower stirring blade and the middle stirring blade, which are arranged below the drum-shaped cylindrical shell-shaped dry/fermentation tank and are subjected to a relatively large load, are formed in a frame structure in which a plurality of plate members are combined with each other,
wherein the first-stage upper stirring blade or the second-stage upper stirring blade, which are positioned above the drum-shaped cylindrical shell dry/fermentation tank and are subjected to a relatively small load compared to the lower stirring blade and the middle stirring blade, is formed by one plate member or in a frame structure in which a plurality of plate members is combined with each other, and
wherein the first-stage upper stirring blade and the second-stage upper stirring blade are formed in different structures according to a magnitude of the load.

3. The high-speed organic waste dry/fermentation apparatus of claim 2, wherein each of the first-stage upper stirring blade and the second-stage upper stirring blade includes an upper front plate, an upper rear plate, an upper top plate and an upper bottom plate positioned along a traveling direction, and an upper protrusion is formed on the upper front plate to reduce a rotational resistance.

4. The high-speed organic waste dry/fermentation apparatus of claim 1, wherein the lower stirring blade includes a lower front plate, a lower rear plate, a lower top plate and a lower bottom plate positioned along a traveling direction, and a lower protrusion is formed on the lower front plate to reduce a rotational resistance.

5. The high-speed organic waste dry/fermentation apparatus of claim 4, wherein the lower bottom plate of the lower stirring blade has a plurality of lower air holes to provide external air to the organic waste to promote fermentation when the lower stirring blade is rotated.

6. The high-speed organic waste dry/fermentation apparatus of claim 3, wherein the middle stirring blade includes a middle front plate, a middle rear plate, a middle top plate and a middle bottom plate positioned along the traveling direction, and a middle protrusion is formed on the middle front plate to reduce the rotational resistance, and
wherein the middle rear plate of the middle stirring blade has a plurality of middle air holes to provide external air to the organic waste to promote fermentation when the middle stirring blade is rotated.

7. The high-speed organic waste dry/fermentation apparatus of claim 6, wherein the middle protrusion has a shape of an isosceles triangle with the middle front plate as a base, and a first plate member and a second plate member as both sides, and a vertex at which the first plate member and the second plate member meet is positioned at a center of the middle front plate to reduce the rotational resistance when the middle stirring blade is rotated, and
wherein the upper protrusion has the shape of the isosceles triangle with the upper front plate as a base, and a third plate member and a fourth plate member as both sides, and a vertex at which the third plate member and the fourth plate member meet is positioned at a center of the upper front plate to reduce the rotational resistance when the first-stage upper stirring blade and the second-stage upper stirring blade are rotated.

8. The high-speed organic waste dry/fermentation apparatus of claim 4, wherein the lower protrusion has a shape of a right triangle in which the lower front plate functions as a base, a firth plate member and a sixth plate member function as both sides, the fifth plate member is arranged to be parallel to the lower bottom plate and the sixth plate member is arranged in an inclined state, and
wherein the shape of the right triangle of the lower protrusion reduces an upward-biased resistance due to the dried/fermented organic matter that accumulates on a bottom of the drum-shaped cylindrical shell dry/fermentation tank when the lower stirring blade is rotated.

9. The high-speed organic waste dry/fermentation apparatus of claim 6, wherein an air supplier configured to supply the external air is connected to a plurality of lower air holes provided in a lower front plate of the lower stirring blade and the plurality of middle air holes, and
wherein the air supplier includes:
a blower configured to supply the external air;
a first supply pipe through which the external air supplied from the blower flows;
a second supply pipe provided inside the stirring shaft and configured to rotate together with the stirring shaft;
a switch configured to supply the external air supplied from the first supply pipe to the second supply pipe;
a third supply pipe provided inside the middle stirring blade and inside the lower stirring blade and configured to supply the external air supplied from the second supply pipe to the plurality of lower air holes and the plurality of middle air holes; and
a branch supply pipe branched at the third supply pipe and configured to supply the external air supplied from the second supply pipe to the plurality of lower air holes and the plurality of middle air holes.

10. The high-speed organic waste dry/fermentation apparatus of claim 9, wherein an air compressor is provided in a certain portion of the first supply pipe, and
wherein air compressor is configured to supply high-pressure air to the plurality of lower air holes and the plurality of middle air hole so that some of the plurality of lower air holes and the plurality of middle air holes are not clogged.

11. The high-speed organic waste dry/fermentation apparatus of claim 10, wherein the drum-shaped cylindrical shell dry/fermentation tank is formed by coupling a plurality of wall modules in a vertical direction and a transverse direction,
wherein the plurality of wall modules has a composite cross-section structure in which a filling material is filled between an inner wall and an outer wall to perform a function of transferring, to the outer wall, a load applied to the inner wall due to a hoof tension generated by a load of the organic waste in the drum-shaped cylindrical shell dry/fermentation tank, and an insulation function to an external temperature, so that the inner wall, the filling material and the outer wall cope with the load generated inside in the drum-shaped cylindrical shell dry/fermentation tank.

12. The high-speed organic waste dry/fermentation apparatus of claim 10, wherein the inner wall is formed of a stainless material and the outer wall is formed of steel,
wherein, when a height of the inner wall is h1 and a height of the outer wall is h2, a relationship of h1>h2 is established,
wherein a lower wall plate is provided to connect the inner wall and a lower end portion of the outer wall so as to integrally form the inner wall and the outer wall, and an upper wall plate is provided to connect an upper end portion of the outer wall and a certain portion of one surface of the inner wall,
wherein a cross-section which constitutes an outline of the plurality of wall modules is formed in a closed state by a first cross-section of the inner wall, a second cross-section of the outer wall, a third cross-section of the upper wall plate and a fourth cross-section of the lower wall plate to obtain a rigid structure, and
wherein the filling material is positioned inside the plurality of wall modules in the closed state to implement both an insulation function and a function of transferring the load applied to the inner wall to the outer wall.

13-15. (canceled)

16. The high-speed organic waste dry/fermentation apparatus of claim 10, wherein an anti-backflow valve for the lower stirring blade and an anti-backflow valve for the middle stirring blade is provided to block the third supply pipe when the organic waste flows into and flows backward from the plurality of lower air holes and the plurality of middle air holes.

17. A high-speed organic waste dry/fermentation apparatus, comprising: a fermentation tank arranged vertically on a ground, having a space in which an organic waste is accommodated, and configured to perform a dry/fermentation process on the organic waste;
a stirrer provided in the fermentation tank and configured to stir the organic waste accommodated in the fermentation tank; and
an air supplier configured to supply air into the fermentation tank through at least one spray stirring blade of the stirrer so that the air supplied from the air supplier is supplied toward an end of the stirrer in a smooth manner,
wherein the stirrer includes:
a stirring shaft provided rotatably inside the fermentation tank while extending vertically at a center of the fermentation tank;
the at least one injection stirring blade provided at intervals along the stirring shaft; and
a driver connected to the stirring shaft to rotate the stirring shaft, and
wherein the air supplier includes:
an external air supplier configured to supply an external air;
a first air supply pipe connected between the external air supplier and a tip of the stirring shaft and configured to supply the external air supplied from the external air supplier;
a plurality of second air supply pipes branched at the first air supply pipe, extending along an interior of the stirring shaft and configured to individually supply the external air using the at least one injection stirring blade;
a third air supply pipe provided inside each of the at least one injection stirring blade and connected to one side of the second air supply pipe extending to the at least one injection stirring blade; and
at least one injection nozzle provided along the third air supply pipe to inject the external air via a discharge port formed in the at least one injection stirring blade,
wherein the external air supplied from the external air supplier is supplied toward an end of the at least one injection stirring blade through a connection structure of the first air supply pipe and the plurality of second air supply pipes and the third air supply pipe.

18. A high-speed organic waste dry/fermentation apparatus, comprising:
a fermentation tank arranged vertically on a ground, having a space in which an organic waste is accommodated, and configured to perform a dry/fermentation process on the organic waste;
a stirrer provided in the fermentation tank and configured to stir the organic waste accommodated in the fermentation tank; and
an air supplier configured to supply air into the fermentation tank through at least one spray stirring blade of the stirrer,
wherein the stirrer includes:
a stirring shaft provided rotatably inside the fermentation tank while extending vertically at a center of the fermentation tank;
the at least one injection stirring blade provided at intervals along the stirring shaft; and
a driver connected to the stirring shaft to rotate the stirring shaft, and wherein the air supplier is configured to selectively supply an external air from a blower and a high-pressure compression air from a compressor.

19. The high-speed organic waste dry/fermentation apparatus of claim 18, wherein the air supplier includes:
a first air supply pipe connected to a tip of the stirring shaft;
a blower provided in the first air supply pipe and configured to supply the external air;
a plurality of second air supply pipes branched at the first air supply pipe, extending along an interior of the stirring shaft and configured to individually supply the external air using the at least one injection stirring blade;
a third air supply pipe provided inside each of the at least one injection stirring blade and connected to one side of the second air supply pipe extending to the at least one injection stirring blade;
at least one injection nozzle provided along the third air supply pipe to inject the external air via a discharge port formed in the at least one injection stirring blade; and a compression air supplier connected to the first air supply pipe and configured to selectively supply a compression air.

20. The high-speed organic waste dry/fermentation apparatus of claim 19, wherein the compression air supplier includes:
a compression pipe connected to the first air supply pipe;
a compressor connected to the compression pipe and configured to supply the compression air;
an air tank configured to store the compression air;
an opening/closing valve configured to open and close the compression pipe; and
a check valve provided in the first air supply pipe in front of the blower and configured to prevent the compression air from flowing backward toward the blower.

21. The high-speed organic waste dry/fermentation apparatus of claim 17, wherein an inner diameter of the first air supply pipe, inner diameters of the plurality of second air supply pipes and an inner diameter of the third air supply pipe become smaller sequentially in an air supply direction.

22. The high-speed organic waste dry/fermentation apparatus of claim 17, wherein the third air supply pipe is fixed on an inner surface in which the discharge port of the at least one injection stirring blade is formed to constitute a single unit, and the at least one injection nozzle formed in the third air supply pipe is directly connected to the discharge port of the at least one injection stirring blade.

23. The high-speed organic waste dry/fermentation apparatus of claim 22, wherein the air supplier further includes a connector configured to selectively connect between the third air supply pipe and the plurality of second air supply pipes, and wherein, when the at least one injection stirring blade is provided on the stirring shaft, the plurality of second air supply pipes in the stirring shaft are connected to the third air supply pipe in the least one injection stirring blade by the connector.
